(19) United States
(12) Patent Application Publication
(10) Pub. No.: US 2014/0040729 A1
(43) Pub. Date: Feb. 6, 2014

(54) PERSONALIZING A WEB PAGE OUTSIDE OF A SOCIAL NETWORKING SYSTEM WITH CONTENT FROM THE SOCIAL NETWORKING SYSTEM DETERMINED BASED ON A UNIVERSAL SOCIAL CONTEXT PLUG-IN

(71) Applicants: Cameron Alexander Marlow, Menlo Park, CA (US); Siddharth Kar, Menlo Park, CA (US); Austin Daniel Haugen, Menlo Park, CA (US); Robert William Cathcart, San Francisco, CA (US)

(72) Inventors: Cameron Alexander Marlow, Menlo Park, CA (US); Siddharth Kar, Menlo Park, CA (US); Austin Daniel Haugen, Menlo Park, CA (US); Robert William Cathcart, San Francisco, CA (US)

(21) Appl. No.: 13/563,623

(22) Filed: Jul. 31, 2012

(51) Int. Cl. G06F 17/00

(52) U.S. Cl. 715/240; 715/234

(57) ABSTRACT

To allow third-party websites to leverage social information maintained in a social networking system, a third-party website may include social information for a user in a web page provided by the third-party website. The social information is obtained from the social networking system. The web page provided by the third-party website includes a social context plug-in that causes a user's browser to obtain social information from a social networking system and to incorporate it within the web page. Customization rules are specified by the web page or by the third-party website to determine how the social information is aggregated and presented on the web page. Hence, the customization rules allow an operator of the third-party website to customize the social content displayed with the web page to provide more relevant information to social networking system users interacting with the third-party website.

### BACKGROUND

This invention relates generally to social networking, and more particularly to extending social content outside of a social networking system by personalizing a third-party website with content from the social networking system.

In a typical social networking system, such as a social networking website, users set up their user profiles and then establish connections with other users of the social networking system. The users often provide information about themselves expressly to the social networking system, such as demographic information and/or a list of the users' interests. Users may also provide information about themselves implicitly to the social networking system, through their actions on the system and interactions with other users. In this way, a social networking system can obtain a rich set of social information about its users, which may be used in a great many ways to enhance a user's experience online.

However, most websites that a user visits online do not have access to this rich set of social information, and in fact most do not even know the identity of their users. Assembling enough information about a user's social connections for these purposes typically requires a system to interact with a large number of users over an extended period of time, and most websites do not have the resources, expertise, or user base required to build and maintain this social information. Accordingly, these systems offer an inferior experience, as any customization or personalization provided by these systems is unlikely to reflect information about the user's social connections and their actions.

For example, a concert website may provide a number of web pages that each contain information about a particular event. Users of a social networking system may comment about the events or artists performing in the events. However, without having access to this social information about the users, the concert website cannot leverage these interactions to enhance the experience of other users visiting the concert website.

### SUMMARY

To allow third-party websites to leverage social information maintained in a social networking system, embodiments of the invention enable a third-party website to incorporate social content for a user in a web page provided by the third-party website. The social content is provided by the social networking system, which maintains social information about the user. The web page provided by the third-party website includes a social context plug-in that causes a user's browser to obtain social information from a social networking system and to incorporate it within the web page (e.g., in an iframe). The social context plug-in provides the social networking system with a set of customization rules specifying how to aggregate and present the social information. The customization rules are defined by an operator of the third-party website and enable the operator to specify what social content is displayed with the web page.

In one embodiment, a user device requests a web page from a web server of a third-party website, which is separate from a web server of a social networking system. The web server from the third-party website sends a markup language document for the requested web page to the user device. The markup language document includes an instruction for a browser application running on the user device to incorporate within the web page information obtained from the social networking system. In one embodiment, the instruction creates a frame within the web page that contains content pulled directly from the social networking system (e.g., an iframe). A request containing customization rules specified in the markup language may be sent from the user device to the social networking system. The customization rules specify at least one social graph object, at least one action type, and aggregation criteria. Thereafter, the user device renders the web page with the social content contained within the frame and displays the rendered web page to the user. In this way, the third-party website has a simple mechanism for incorporating social content for the user, without requiring the third-party website itself to maintain—or even have access to—the user's social information.

Embodiments of the invention enable various types of social content to be provided on the third-party website. In one example, the social content may comprise a window, which contains a selection of actions performed by the user's connections and related to a particular person, entity, place or thing. The actions may include various actions tracked, or otherwise collected, by the social networking system that a user may perform, such becoming a fan of (or “liking” or otherwise expressing interest in) something, posting a link, commenting, posting content, listening to a song, reading a news story, watching a video, purchasing an item, recommending a restaurant, or indicating that they visited a geographic location. For example, a web page for a musician may contain a window that lists a user's friends' that have attended a concert that the musician performed in.

The social content provided by the social networking system may be formatted, filtered and/or ranked based on a number of criteria, including, without limitation, the user's interests, demographic information, the affinity for other objects in the social networking system, location information, geo-location information, keywords or tags (either dictated by the third-party website and/or by the user), and a decay factor. The criteria may be dictated by the third-party website, for example, by passing the customization rules specified in the markup language document to the social networking system. For example, a news website may not care about the user's location, whereas a restaurant review website would care. In such a case, the third-party website may pass customization rules that indicate to the social networking system whether the social content should be filtered to exclude content that does not match the user's location. The third-party website need not know the user's location, as the filtering may be done entirely by the social networking system. In another embodiment, the filtering and/or ranking need not be specified by the third-party website, and can instead be perform by the social networking system. For example, the social networking system may personalize content for a user by applying an affinity function for the user to each content item, thereby providing the user with the content that is most likely to be relevant to the user. A great number of variations and applications are possible, as will be appreciated.

### BRIEF DESCRIPTION OF THE DRAWINGS

FIG. 1 is a high level block diagram illustrating a process for personalizing a third-party website with content from a social networking system, in accordance with one embodiment of the invention.

FIG. 2 is a high level block diagram of a social networking system, in accordance with one embodiment of the invention.

FIG. 3 is a high level block diagram of a defined graph structure representing a user action, in accordance with an embodiment of the disclosure.

FIG. 4 is a high level block diagram illustrating various modules for providing social content to third-party web pages based on customization rules.

FIG. 5 is an interaction diagram a process for personalizing a third-party website with content from a social networking system, in accordance with an embodiment of the invention.

The figures depict various embodiments of the described methods and system and are for purposes of illustration only. One skilled in the art will readily recognize from the following discussion that alternative embodiments of the methods and systems illustrated herein may be employed without departing from the principles of the methods and systems described herein.

### DETAILED DESCRIPTION

### Overview

A social networking system offers its users the ability to communicate and interact with other users of the social networking system. Users join the social networking system and add connections to a number of other users to whom they desire to be connected. Users of social networking system can provide information describing them which is stored as user profiles. For example, users can provide their age, gender, geographical location, education history, employment history and the like. The information provided by users may be used by the social networking system to direct information to the user. For example, the social networking system may recommend social groups, events, and potential friends to a user. A social networking system may also enable users to explicitly express interest in a concept, such as celebrities, hobbies, sports teams, books, music, and the like. These interests may be used in a myriad of ways, including targeting advertisements and personalizing the user experience on the social networking system by showing relevant stories about other users of the social networking system based on shared interests.

A social graph includes nodes connected by edges that are stored on a social networking system. Nodes include users and objects of the social networking system, such as web pages embodying concepts and entities, and edges connect the nodes. Edges represent a particular interaction between two nodes, such as when a user expresses an interest in a news article shared by another user about “America's Cup.” The social graph may record interactions between users of the social networking system as well as interactions between users and objects of the social networking system by storing information in the nodes and edges that represent these interactions. Custom graph object types and graph action types may be defined by third-party developers as well as administrators of the social networking system to define attributes or properties of the graph objects and graph actions. For example, a graph object for a movie may have several defined object properties, such as a title, actors, directors, producers, year, and the like. A graph action type, such as “purchase,” may be used by a third-party developer on a website external to the social networking system to report custom actions performed by users of the social networking system. In this way, the social graph may be “open,” enabling third-party developers to create and use the custom graph objects and actions on external websites.

Third-party developers may enable users of the social networking system to express interest in web pages hosted on websites external to the social networking system. These web pages may be represented as page objects in the social networking system as a result of embedding a widget, a social plug-in, programmable logic or code snippet into the web pages, such as an iframe. Any concept that can be embodied in a web page may become a node in the social graph on the social networking system in this manner. As a result, users may interact with many objects external to the social networking system that are relevant to a keyword or keyword phrase, such as “Justin Bieber.” Each of the interactions with an object may be recorded by the social networking system as an edge object. Enabling third-party developers to define custom object types and custom action types is described further in “Structured Objects and Actions on a Social Networking System,” U.S. application Ser. No. 13/239,340 filed on Sep. 21, 2011, which is hereby incorporated by reference.

A social networking system may enable third-party websites to leverage social information maintained by the social networking system by enabling the third-party website to insert a social plug-in into its web pages. The social plug-in comprises instructions that, when executed, cause a browser to obtain social content from the social networking system and to incorporate it within the third-party web page (e.g., in an iframe). The social plug-in may include rules specifying how information and content from the social networking system are aggregated and rendered. In one embodiment, the rules are specified by the operator of the third-party website. Hence, the rules allow the operator of the third-party website to define different sets of social content to be retrieved from the social networking system. This allows the third-party website operator to define the social context of the third-party webpage without providing the third-party website with direct access to a user's social information maintained by the social networking system.

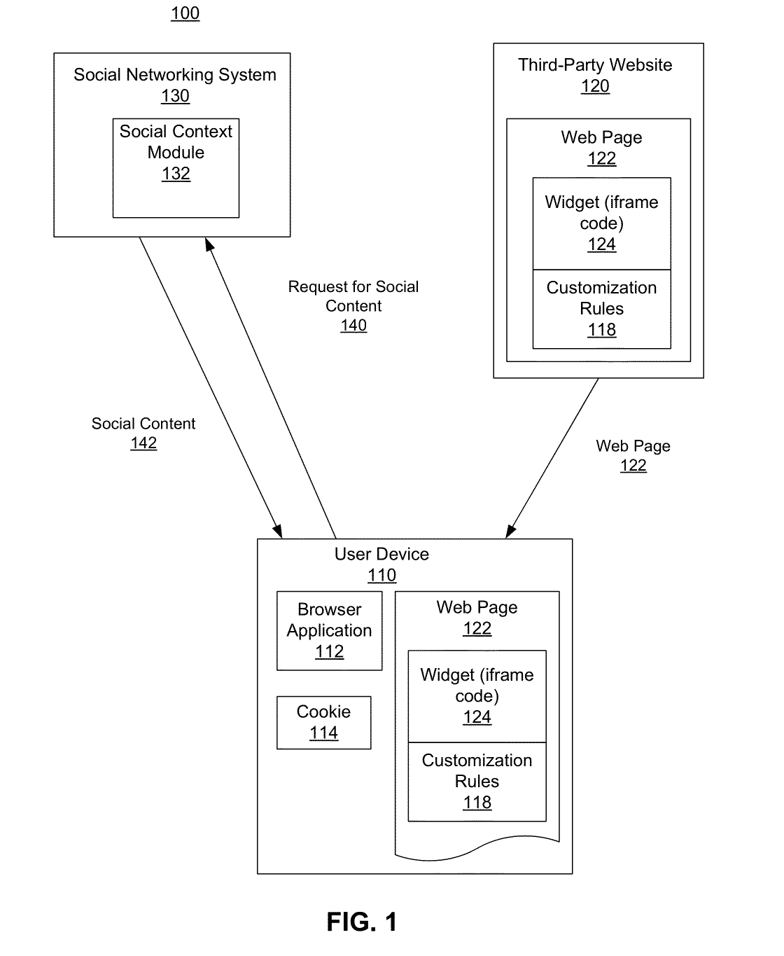

FIG. 1 is a high level block diagram of a process for personalizing a third-party website with content from a social networking system. The browser application 112 of the user device 100 renders a web page 122 from a third-party website 120. The web page 122 includes a widget 124 comprising instructions that, when executed by the browser application 112 of the user device 110, causes the browser application 112 to send a request 140 for social content to the social networking system 130. The request 140 includes customization rules 118 used by the social networking system to identify, aggregate, and format social content 142. The customization rules 118 may be specified in the web page 122 itself. By executing instructions of the widget 124 included in the web page 122, the browser application 112 retrieves social content 142 from the social networking system 130 and displays the social content 142 based on the customization rules 118. Hence, the widget 124 allows a web page 122 from the third-party website 120 to provide social content 142 (or “social information”) from the social networking system 130 in addition to content from the third-party website 120.

In one embodiment, the user device 110 includes a cookie 114 that includes data indicating whether a user of the user device 110 is logged into the social networking system 130. The cookie 114 indicates whether the user of the device 110 is involved in an active session where the user device 110 is exchanging data with the social networking system 130.

The third-party website 120 comprises one or more web servers that communicate with the user device 110 via a network. The one or more web servers include one or more web pages 122 for communication to the user device 110 using the network. The third-party website 120 is separate from the social networking system 130. For example, the third-party website 120 is associated with a first domain while the social networking website is associated with a separate social networking domain. A web page 122 included in the third-party website 120 comprises a markup language document including a widget 124 and customization rules 118. In various embodiments, the webpage 122 comprises a data file including extensible markup language (XML) data, extensible hypertext markup language (XHTML) data or other markup language data.

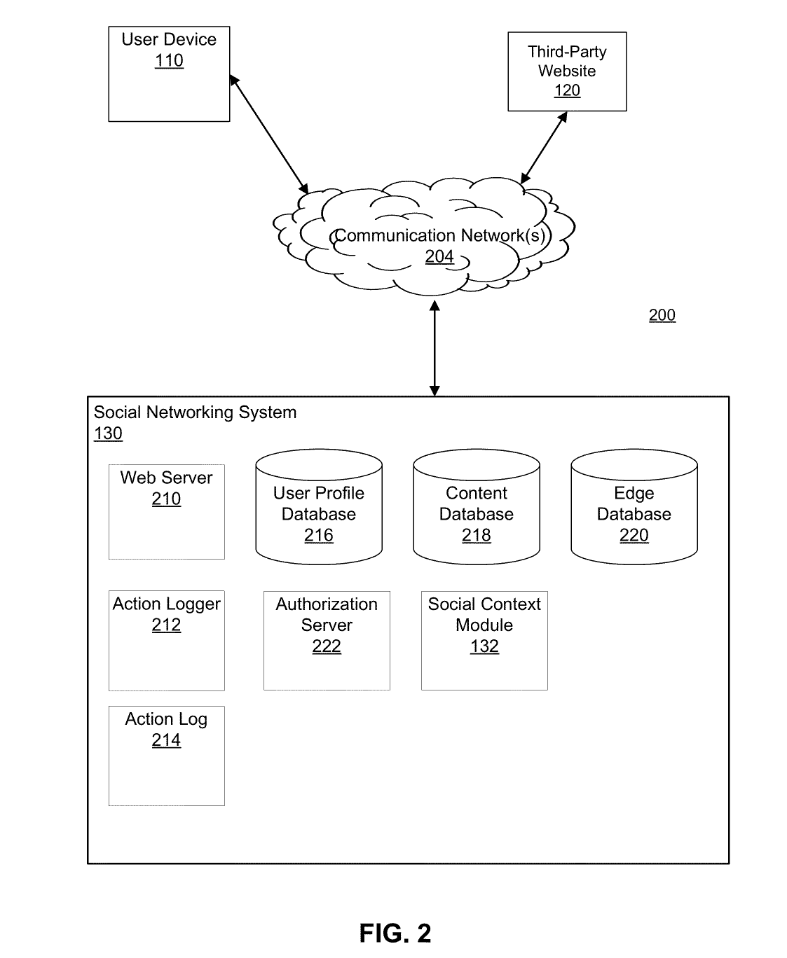

The social networking system 130 comprises one or more computing devices storing a social network, or mapping of a social graph, comprising a plurality of users and providing users of the social network with the ability to communicate and interact with other users of the social network. The social networking system 130 is further described below in conjunction with FIG. 2.

### System Environment

FIG. 2 is a high level block diagram illustrating a system environment 200, in accordance with one embodiment. The system environment 200 comprises one or more user devices 110, the social networking system 130, a network 204, and one or more third-party websites 120. For purposes of illustration, the embodiment of the system environment 200 shown by FIG. 2 includes a single third-party website 120 and a single user device 110. However, in other embodiments, the system environment 200 may include more user devices 110 and/or more third-party websites 120. In some embodiments, the social networking system 130 is implemented as a single server, while in other embodiments it is implemented as a distributed system of multiple servers. For convenience of explanation, the social networking system 130 is described below as being implemented on a single server system.

In certain embodiments, the social networking system 130 is operated by a social network provider, whereas the third-party websites 120 are separate from the social networking system 130 in that they may be operated by different entities. In various embodiments, however, the social networking system 130 and the third-party websites 120 operate in conjunction to provide social networking services to users of the social networking system 130. In this sense, the social networking system 130 provides a platform, or backbone, which other systems, such as third-party websites 120, may use to provide social networking services and functionalities to users across the Internet.

The communication network(s) 204 can be any wired or wireless local area network (LAN) and/or wide area network (WAN), such as an intranet, an extranet, or the Internet. It is sufficient that the communication network 204 provides communication capability between the client devices 110, the third-party website 120, and the social networking system 130. In some embodiments, the communication network 204 uses the HyperText Transport Protocol (HTTP) and the Transmission Control Protocol/Internet Protocol (TCP/IP) to transmit information between devices or systems. HTTP permits the client devices 110 to access various resources available via the communication network 204. The various embodiments of the invention, however, are not limited to the use of any particular protocol.

The user device 110 comprise one or more computing devices that can receive user input and can transmit and receive data via the network 204. In one embodiment, a user device 110 is a conventional computer system executing, for example, a Microsoft WINDOWS®-compatible operating system (OS), Apple OS X®, and/or a Linux distribution. In another embodiment, a client device 110 may be a device having computer functionality, such as a personal digital assistant (PDA), mobile telephone, smart-phone, etc. The client device 110 is configured to communicate via network 204. The client device 110 can execute an application, for example, a browser application, that allows a user of the client device 110 to interact with the social networking system 130. In another embodiment, the client device 110 interacts with the social networking system 130 through an application programming interface (API) that runs on as native operating system of the user system 110, such as iOS® and ANDROID™

The web server 210 links the social networking system 130 to one or more user devices 110 and/or to one or more third-party websites 120 via the network 204; the web server 210 serves web pages, as well as other web-related content, such as JAVA®, FLASH®, XML, and so forth. The web server 210 may provide the functionality of receiving and routing messages between the social networking system 130 and the user devices 110, for example, instant messages, queued messages (e.g., email), text and SMS (short message service) messages, or messages sent using any other suitable messaging technique. The user may send a request to the web server 210 to upload information from a user device 110, for example, images or videos, which is stored in the content database 218. Additionally, the web server 210 may provide API functionality to send data directly to native user device operating systems, such as iOS®, ANDROID™, webOS, and BlackBerry OS.

The action logger 212 is capable of receiving communications from the web server 210 about user actions on and/or off the social networking system 130. The action logger 212 populates the action log 214 with information about user actions, allowing the social networking system 130 to track various actions taken by its users within the social networking system 130 and outside of the social networking system 130. Any action that a particular user takes with respect to another user is associated with each user's profile through information maintained in the action log 214 or in a similar database or other data repository. Examples of actions taken by a user within the social network 130 that are identified and stored may include, for example, adding a connection to another user, sending a message to another user, reading a message from another user, viewing content associated with another user, attending an event posted by another user or other actions interacting with another user. In addition to interactions with other users, social networking system users may also perform actions to interact with various objects on the social networking system 130, including commenting on posts, sharing links, and checking-in to physical locations via a mobile device. Thus, when a user takes an action within the social networking system 130, the action is recorded in the action log 214. In one embodiment, the social networking system maintains the action log 214 as a database of entries. When an action is taken within the social networking system 130, an entry for the action is added to the action log 214.

Additionally, the action log 214 may be used by the social networking system 130 to track users' actions on the social networking system 130 as well as external websites that communicate information back to the social networking system 130, such as the third-party website 120. User actions may be associated with an entity outside of the social networking system 130, such as a third-party website 120 that is separate from the social networking system 130. For example, the action logger 212 receives data describing a user's interaction with a third-party website 120 from the web server 210. Examples of actions where a user interacts with a third-party website 120 includes a user expressing an interest in a third-party website 120 or another entity, a user posting a comment to the social networking system 130 that discusses a third-party website 120, or a web page 122 within the third-party website 120, a user posting to the social networking system 130 a Uniform Resource Locator (URL) or other identifier associated with a third-party website 120, a user attending an event associated with a third-party website 120 or any other action by a user that is related to a third-party website 120. For example, an e-commerce website that primarily sells luxury shoes at bargain prices may recognize a user of a social networking system 130 through social plug-ins that enable the e-commerce website to identify the user of the social networking system. Because users of the social networking system 130 are uniquely identifiable, e-commerce websites, such as this luxury shoe reseller, may use the information about these users as they visit their websites. The action log records data about these users, including viewing histories, advertisements that were clicked on, purchasing activity, and buying patterns. Hence, interactions between a social networking system user and a third-party website 120 may also be stored in the action log 214.

The information stored in the user profile database 216, content database 218, and edge database 220 store social graph objects. As discussed in more detail herein, user profile objects and content objects may correspond to nodes in the social graph and edge objects may represent relationships between nodes in the social graph.

The user profile database 216 stores user profile objects. User profile objects include declarative profile information about a user, inferred or implicit information about a user from the user's actions on the social networking system 130 and/or outside of the social networking system, information about the user's activities and interests, and information about the user's friends or connections in the social networking system. Examples of information stored in a user profile object includes biographic, demographic, and other types of descriptive information, such as work experience, educational history, gender, hobbies or preferences, location, and the like. In one embodiment, a user profile object for a user includes various data fields for storing various information items about the user, where each data field may store a different type of information about a user. Examples of the information stored by the data fields include phone numbers, instant message screen names, addresses, websites, current city, hometown, gender, birthday, names of family members, languages spoke, a description, education history, work history, religious affiliations, political views, favorite quotes, favorite sports, favorite foods, favorite books, favorites movies, interests, activities, names of pets, information about friends, and the like.

A user profile object for a user may also include the user's affinity scores for objects in the social networking system 130. An affinity score measures or indicates a user's affinity for an object in the social networking system 130. In one embodiment, affinity scores of users for an object may be determined by the social networking system 130 based on the user's interactions with the specified object over time. In particular, affinity scores of the users for an object may be determined based on edge objects containing information describing the interactions between the user and object. Example embodiments of computing affinity scores are described in a related application, “Contextually Relevant Affinity Prediction in a Social Networking System,” U.S. patent application Ser. No. 12/978,265, filed on Dec. 23, 2010, which is hereby incorporated by reference in its entirety. The user profile may also store other information provided by the user, for example, images or videos. In certain embodiments, images of users may be tagged with identification information of users of the social networking system 130 displayed in an image. The user profile database 216 also maintains references to the actions stored in an action log and performed on objects in the content database 218.

The edge database 220 stores edge objects. Edge objects connect objects in the social graph and include information about a user's interactions with other objects on the social networking system 130, such as clicking on a link shared with the user, sharing photos with other users of the social networking system, posting a status update message on the social networking system 130, and other actions that may be performed internal or external to the social networking system 130. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 130, such as expressing interest in a page on the social networking system, sharing a link with other users of the social networking system, and commenting on posts made by other users of the social networking system.

Edge objects in the edge database 220 include information about the edges, such as affinity scores for objects, interests, and other users. Affinity scores may be computed by the social networking system 130 over time to approximate a user's affinity for an object, interest, and other users in the social networking system 130 based on the actions performed by the user. Multiple interactions between a user and a specific object may be stored in one edge object in the edge database 220, in one embodiment. For example, a user that plays multiple songs from Lady Gaga's album, “Born This Way,” may have multiple edge objects for the songs, but only one edge object for Lady Gaga. Edge objects may also include information about user interactions outside of the social networking system 130. For example, interaction information may be collected from third-party systems (e.g., sites and applications) that use social plug-ins that enables users to interact with social content from the social networking system 130.

The content database 218 stores content objects. A content object may include any type of object on the social networking system 130, such as a page post, a status update, a photo, a video, a link, a shared content item, a gaming application achievement, a check-in event at a local business, and so on. Content objects include objects created by users of the social networking system 130, such as status updates that may be associated with photo objects, location objects, and other users, photos tagged by users to be associated with other objects in the social networking system 130, such as events, pages, and other users, and applications installed on the social networking system 130. In some embodiments, the content objects are received from third-party applications or third-party applications separate from the social networking system 130. Content “items” represent single pieces of content that are represented as objects in the social networking system 130. In this way, users of the social networking system 130 are encouraged to communicate with each other by posting text and content items of various types of media through various communication channels, increasing the interaction of users with each other and increasing the frequency with which users interact within the social networking system 130.

The authorization server 222 enforces one or more privacy settings of the users of the social networking system 130. A privacy setting of a user determines how particular information associated with a user can be shared. In one embodiment, a privacy setting specifies particular information associated with a user and identifies the entity or entities with whom the specified information may be shared. Examples of entities with which information can be shared may include other users, applications, third-party websites 120 or any entity that can potentially access the information. Examples of information that can be shared by a user include user profile information like profile photo, phone numbers associated with the user, user's connections, actions taken by the user such as adding a connection, changing user profile information and the like.

The privacy setting specification may be provided at different levels of granularity. In one embodiment, a privacy setting may identify specific information to be shared with other users. For example, the privacy setting identifies a work phone number or a specific set of related information, such as, personal information including profile photo, home phone number, and status. Alternatively, the privacy setting may apply to all the information associated with the user. Specification of the set of entities that can access particular information may also be specified at various levels of granularity. Various sets of entities with which information can be shared may include, for example, all friends of the user (i.e., all users connected to the user), all friends of friends, all applications, all third-party websites 120, specific third-party websites 120, or all external systems.

One embodiment uses an enumeration of entities to specify the entities allowed to access identified information. For example, the user may select a list of third-party websites 120 e allowed to access certain information. Another embodiment allows the entity specification to comprise a set of entities along with exceptions identifying entities that are not allowed to access the information or a subset of the information. For example, a user may allow all third-party websites 120 to access the user's work information but specify a list of third-party websites 120 that are not allowed to access the work information. The list of exceptions that are not allowed to access certain information may be referred to as a “block list.” External systems, such as third-party websites 120, included on a user-specified a block list are blocked from accessing the information specified in the privacy setting associated with or including the block list. Various combinations of granularity of specification of information and the granularity of specification of entities with which information is shared are possible, i.e., all personal information may be shared with friends whereas all work information may be shared with friends of friends.

For example, a user's privacy setting indicates that a first friend is allowed to access the user's work phone number and the user's mobile phone number while preventing the first friend from accessing other information about the user, such as the user's profile photo or the user's list of friends. However, the user's privacy setting indicates that a second friend is allowed to access the user's friend list. The information associated with a user includes actions taken by a user such as the action of adding a new friend. The user can completely block another user or an application from accessing any information associated with the user 130. A user or an application that is completely blocked by the user does not have access to any information associated with user.

The authorization server 222 includes logic to determine if certain information associated with a user can be accessed by a user's friends, third-party websites 120 and/or other applications and entities. For example, a third-party website 120 that attempts to access a user's comment about a uniform resource locator (URL) associated with the third-party website 120 must get authorization from the authorization server 222 to access the user's work phone number. Based on the user's privacy settings, the authorization server 222 determines if another user, a third-party website 120, an application or another entity is allowed to access information associated with the user, including information about actions taken by the user. For example, the authorization server 222 uses a user's privacy setting to determine if the user's comment about a URL associated with the third-party website 120 can be accessed by the third-party website 120. This enables a user's privacy setting to specify which other users, or other entities, are allowed to receive data about the user's actions or other data associated with the user.

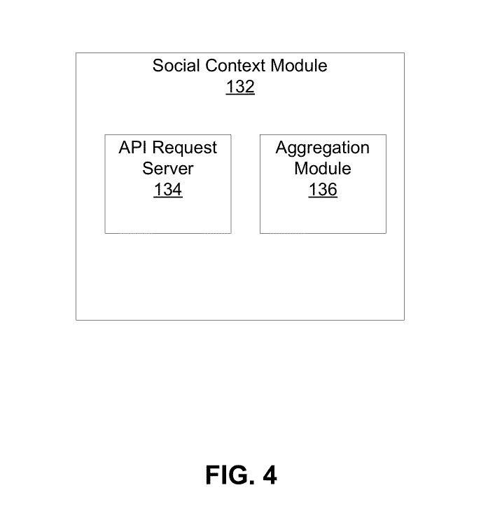

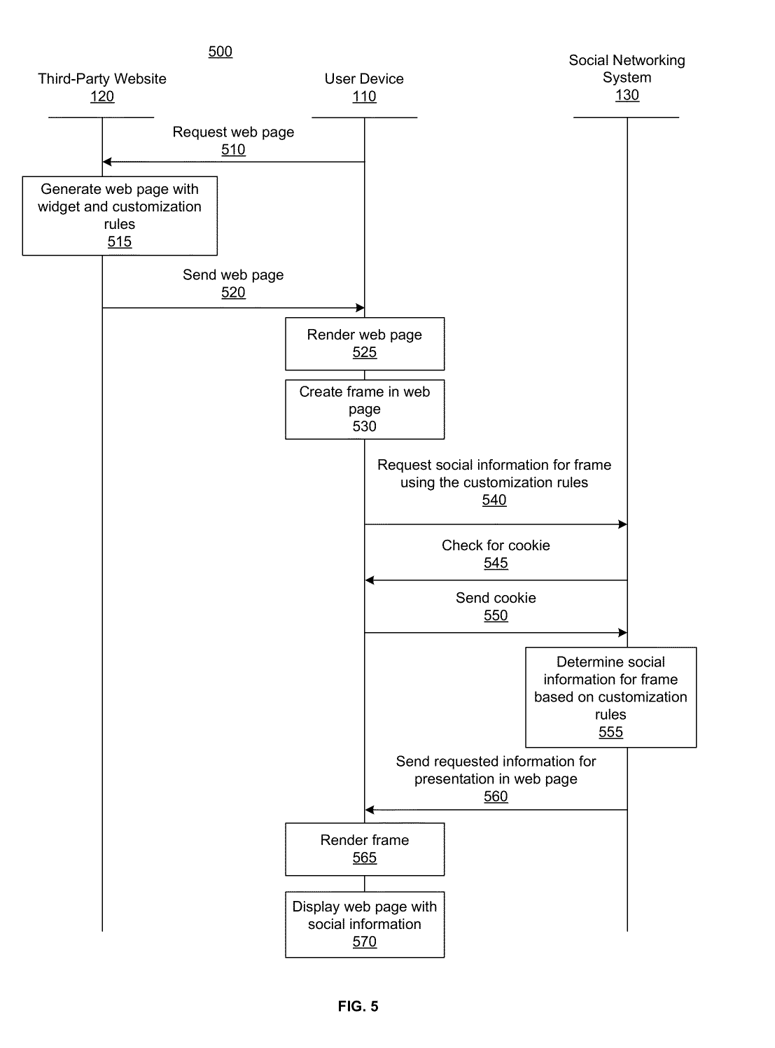

The social context module 132 identifies social information for presentation in a web page provided by a third-party website 120. The social information is identified based on customization rules included in a request for information and information associated with the user. The customization rules specify one or more objects, one or more action types and aggregation criteria. The social context module 132 identifies one or more objects from the content database 219 matching the one or more objects in the customization rules. Additional objects are then identified based on the one or more action types in the customization rules. Based on the identified actions and objects, information is aggregated based on the aggregation criteria, which may specify objects types, object properties, or action types, or any combination thereof, with the aggregated data subsequently transmitted to a third-party website 120 or to a user device 110. The social content module is further described below in conjunction with FIGS. 4 and 5.

### Structure for Graph Actions and Graph Objects

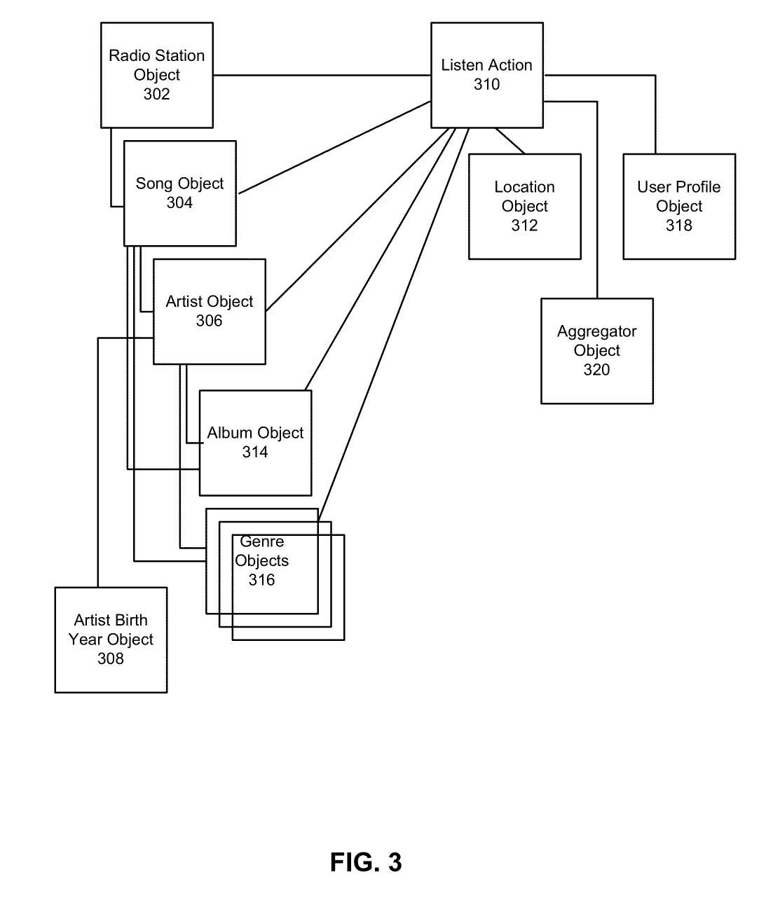

FIG. 3 is a high-level block diagram of a defined graph structure representing a graph action and its relationship to graph objects, in accordance with an embodiment of the disclosure. Although only one action is illustrated, the listen action 310, a variety of actions are available to be defined within the social networking system 130. For example, users may read, purchase, sell, watch, want, play, achieve, take, recommend, review, visit, and comment on various objects, such as products, music, sporting matches, and movies. Entities external to the social networking system 130 may define these graph actions and graph objects for publishing into a social graph on the social networking system 130. The graph actions and graph objects may be performed by users on third-party websites 120 as well as on the social networking system 130.

As illustrated in FIG. 3 and discussed above, an example embodiment involves listening to music on a third-party website 120, such as an Internet radio website. The listen action 310 may be defined for other external systems 120, including a stand-alone desktop application connected to a network, podcasts, terrestrial radio stations broadcasting through the Internet, a virtual music locker website, and a music streaming subscription service website. As mentioned above, in some embodiments, actions such as the listen action 310 can be defined to be open-ended so that new objects, such as playlists, podcasts, and streaming libraries, though not pictured, may be acted upon by the listen action 310. The listen action 310, or other actions, may be defined by an entity external to the social networking system 130 through a tool provided by the social networking system 130 that, in one embodiment, enables the entity to define action properties associated with an action type. For example, types of objects associated with the listen action 310 may be defined. The tool may expose a new action type on a web page on the social networking system 130 to enable entities external to the social networking system 130 to access the new action type.

Object properties of graph objects may be defined by an entity external to the social networking system 130, such as a third-party website 120. For example, object properties of a song object 304 may include a title, a duration, an artist object 306, an album object 314, and several genre objects 316, for example. As another example, object properties of an artist object 306 may include an artist name, an album object 314, several genre objects 316, and an artist birth year object 308, for example. Graph objects may also include associations with other graph objects, allowing multiple objects to be related to each other. For example, a radio station object 302 may include an association with a song object 304 that is created by an application. For example, a radio station object 302 may include a playlist of multiple song objects 304 that are to be played for users listening to the radio station associated with the radio station object 302. In one embodiment, objects have standard object properties, such as a title, description, image, and URL. Other object properties may be defined by the entity external to the social networking system 130.

In the example of FIG. 3, a radio station object 302 may be defined as having a name, such as “99.7 FM” or “Britney Spears Channel.” The radio station object 302 may include properties, such as being owned by a corporation, being broadcast on specific internet URLs, etc. The radio station object 302 is linked to, or associated with, a song object 304. A song object 304 represents one song that has played on the radio station. The song object 304 is linked to an artist object 306 that performs the song. The artist object 306 may be linked to an artist birth year object 308 that represents the birth year that the artist was born. For example, if an artist object 306 represented “Britney Spears,” then the artist object 306 would be linked to the “1981” birth year object 308 because the third-party developer would know that Britney Spears was born in 1981. Similarly, the owner of the song object 304 for “Till the World Ends,” a song by Britney Spears, would also associate that song object 304 with the album object 314 for “Femme Fatale” and genre objects 316 for “pop,” “dance-pop,” and “electropop.” Such information may be manually defined or automatically associated using information about the graph objects stored in databases.

A third-party application for an internet radio website may define objects for the radio stations, songs, artists, artist birth years, albums, and genres in a variety of ways, such as using the tool described above, by describing objects in web pages on external systems 120 in markup language documents using tags or any other suitable manner. In addition to defining objects, one or more actions may be defined and associated with objects. For example, a listen action 310 may be defined by a social networking system administrator or a third-party developer. The entity defining the listen action 310 may be the same or different than the entity defining one or more of the objects described above. The listen action 310, like most actions, may be associated with a location object 312 to identify and record a geographic location where an action has taken place. The listen action 310 may also be associated with a user profile object 318 for the user that performing the action. Finally, a property of the listen action 310 may include an aggregator object 320 that identifies how many times the listen action 310 has been performed. In various embodiments, the number of performed actions may be broken down by a variety of criteria. For example, the number of performed actions may be segmented by user, by location, by groups of users, or by any identifiable node in the social networking system 130.

In one example, a user of a social networking system 130 visits an Internet radio website hosted by a third-party website 120 after previously giving permission to share actions taken on the Internet radio website hosted on the third-party website 120. The third-party website 120 may encode tags in a markup language document to create objects in the social networking system 130 as users perform actions on the internet radio website, such as listening to radio stations. As the user listens to music on the internet radio website, a listen action 310 may be recorded in an action log or communicated to the social networking system in association with the user profile object 318 for the user. The action log may include a user identifier, an action type of the graph action, an object identifier, time, date, and other metadata, such as object properties and action property values, such as how long the user listened to a song before skipping it. If the user is using a mobile device with GPS capability or if geographic location is otherwise available, then a location object 312 for that location may also be associated with the listen action 3107.

An aggregator object 320 associated with the listen action 310 may a count how many times the action has been performed. In one embodiment, any object, such as a radio station object 302, song object 304, artist object 306, album object 314, genre objects 316, may be configured by a third-party developer or administrator of the social networking system as objects that may be aggregated upon. Because the graph structure is completely customizable, aggregation, as well as other statistical functions such as summation, frequency, distance, averages, and deviances from norm, may be performed on specified objects. A variety of data may be determined by querying the graph actions and graph objects. For example the number of hours spent listening to Lady Gaga, represented by an artist object 306, may be determined by querying the structured graph actions and graph objects and may be calculated on any set of users of the social networking system 130. As the user listens to a song on a radio station, the listen action 310 may be associated with the corresponding radio station object 302, song object 304, as well as the linked artist object 306, album object 314, and genre objects 316 for the song. The artist birth year object 308 is not directly linked to the listen action 310, but instead, is directly linked to the artist object 306. Thus, a specialized query may be utilized to generate various data visualizations, such as the top artists listened to, sorted by birth year.

Personalizing a Third-Party Web Page with Content from the Social Networking system

FIG. 4 illustrates a high level block diagram of the social context module 132 in further detail, in one embodiment. The social context module 132 includes an API request server 134 and aggregation module 136. These modules may perform in conjunction with other modules to respond to requests for social content.

The Application Programming Interface (API) request server 134 allows one or more third-party websites 120 to access information from the social networking system 130 using one or more APIs. The API request server 134 parses requests from user devices and calls a function or module associated with the request to generate an appropriate response. The response may be communicated back to the requestor (e.g., third-party website 120) by the API request server 134 or another module. For example, responsive to an API request, the API request server 134 collects data associated with a user and communicates the collected data to the third-party website 120. The API request server 134 may also allow third-party websites 120 to send information to social networking website by calling APIs. In some embodiments, the API request server 134 identifies customization rules in a received request and sends the customization rules to the aggregation module 136, which uses the information to determine social content to provide in response to the request.

The aggregation module 136 determines social content or social information based on customization rules. In some embodiments, the customization rules specify at least one social graph object, at least one action type, and aggregation criteria. The social graph object may be any object maintained by the social networking system. The social graph object may store information for a person, entity, place, thing or concept. For example, the social graph object may store information for a user's profile, a wall post, a news story, a picture, a video, a song, an advertisement, a group page, an application, a page for a group, a page for an event, a page for an entity, a page for a place, and a page for a public figure. In some embodiments, at least one of the specified graph objects corresponds to a profile object, content object, or edge object. In some embodiments, at least one of the specified graph objects corresponds to a graph object received from a third party website.

The at least one action type may correspond to users actions on and off the social networking system. For example, the types of actions may include read, commented, liked, posted, shared, recommended, voted, reviewed, RSVP'd, messaged, chatted, emailed, responded, viewed, watched, played, listened, purchased, attended, checked in, wants, exercised, ran, walked, swam, hiked, bike, and the like. In some embodiments, one of the action types is defined by a third-party entity. For example, an exercise related application may define an exercise action type. The aggregation module 136 identifies a set of object from which to collect social information using an object and action type specified in the customization rules to identify a set of graph objects from which to collect social information. The aggregation module 136 identifies an object stored in the social networking system 130 matching an object specified in the customization rules and additional objects. Because an object may be associated with a set of possible action types or edge objects, additional objects are identified by the aggregation module 136 based on based one or more action types in the customization rules. For example, if the customization rules specify an object storing information about a musician and action types of “listen” and “attend concert,” the aggregation module 136 identifies the object for the musician and additional objects associated with the musician object by an edge objects corresponding to action types of “listen” and “attend concert.” As discussed above, an edge object represents an action having an action type and indicates a relationship between two or more graph objects, allowing identification of additional objects based on the customization rules. Hence, the aggregation module 136 identifies at least one object in the social networking system 130 based on the object in the customization rules and additional objects based on one or more action types specified in the customization rules.

In some embodiments, objects identified by the aggregation module 136 include information about connections of a user. Using the previous example, the aggregation module 136 identifies connections of the user that have listened to songs by the musician or attended a concert in which the musician performed. In some embodiments, objects identified by the aggregation module 136 include information about other users connected to a user connected to the user (i.e., the user's second degree connections).

After identifying objects using the aggregation criteria, the aggregation module 136 aggregates information from the identified objects based on aggregation criteria in the customization rules. The aggregation criteria may specify objects types, object properties, action types, or any combination thereof. Using the previous example, if the aggregation criteria specifies an album or a song, the aggregation module 136 may aggregate information from the identified set of objects based on the song or the album.

In some embodiments, the customization rules include display criteria specifying how the aggregated information is formatted or displayed. For example, the display criteria may specify that the aggregated information is to be displayed in a table or chart. In some embodiments, the customization rules specify filtering criteria. The filtering criteria may specify information to exclude from the aggregated information. The filtering criteria may specify object types, object properties, and action types of objects not to aggregate information from. In some embodiments, the customization rules may specify ranking criteria for the aggregated information. Examples of the ranking criteria include a user's interests, demographic information, affinity for objects in the social networking system, location information, geo-location information, keywords, and a decay factor. In some embodiments, the display criteria specifies how the information is grouped. For example, information about a musician may be grouped by song or album.

In some embodiments, the aggregation module 136 aggregates information for a third-party website 120 without receiving customization rules from the third-party website. The third-party request may send the aggregation module 136 a request that includes information identifying the third-party website 120 or a web page of the third-party website 120. The aggregation module 136 may store a table specifying customization rules for various web pages of third-party websites 120. The aggregation module 136 uses customization rules from the table to aggregate information for presentation by different web pages. Process

FIG. 5 is an interaction diagram of a process 500 for providing social content to a third-party website 120. Portions of process 500, as shown in FIG. 5, are performed at a server system (e.g., social networking system 130) having one or more processors and non-transitory memory, which stores one or more instructions to be executed by the one or more processors of the server system. The one or more instructions stored in the memory of the server system include instructions for portions of process 500 discussed below. Portions of process 500, as shown in FIG. 5, are performed at a user device 110 having one or more processors and non-transitory memory storing instructions to be executed by the one or more processors of the user device 110. The instructions stored by the non-transitory memory of the user device 110 include instructions for portions of process 500 discussed below. Portions of process 500, as shown in FIG. 5, are performed at a server hosting a website (e.g., third-party website 120) having one or more processors and non-transitory memory, which includes instructions to execute portions of the process 500 when executed by the one or more processors of the server hosting the third-party website. In the embodiment shown by FIG. 5, the third-party website 120 is separate from the social networking system 130. For example, the third-party website 120 may be associated with a separate and distinct domain from the domain of the social networking system 130.

Initially, a user device 110 requests 510 a web page from the third-party website 120. For example, a user of the user device 110 enters a uniform resource locator (URL) or other identifier associated with the web page into a browser application operating on the user device 110. The browser application identifies the third-party website 120 associated with the received URL or other identifier and requests a web page associated with the received URL or other identifier from the identified third-party website 120.

After receiving the request for the web page, the third-party website 120 generates 515 the requested web page using locally-stored data. For example, the generated web page describes the content and formatting of the web page based on stored data. The generated web page includes a widget and customization rules. The widget comprises instructions that, when executed by a browser application of the user device 110, causes the browser application to retrieve and display data from the social networking system 130. More specifically, the widget includes instructions that cause the browser application to send a request for social information to the social networking system 130 including the customization rules and to display social information received from the social networking system 130 in a portion of the web page. In one embodiment, the social information is displayed in an iframe within the web page.

The customization rules identify characteristics or attributes of social information retrieval from the social networking system 130. The customization rules may be specified by the operator of the third-party website 120 and enable the operator to specify different sets of social information. Hence, the customization rules provide a third-party website operator with greater control and customization over the social information that is provided to a web page provided by the third-party website. In some embodiments, the customization rules specify at least one object, at least one action type, and aggregation criteria. As discussed above, the specified object may store information for a person, entity, place, thing, or concept. In one example, the customization rules may specify a list of users in San Francisco who like a band by specifying a graph object corresponding to the band and an action type of “like.” In this example, the customization rule may comprise {‘action.type’: ‘like, ‘page’: <pageid for the band>, ‘aggregate’: ‘San Francisco’}.

In some embodiments, the customization rules are included within the web page or within the code comprising the widget. For example the web page may include an instruction such as <ifame src=“http://www.socialnetwork.com/social context/; ‘action.type’: ‘like, ‘page’: <pageid for the band>, ‘aggregate’: ‘San Francisco’; height=300&amp; width=500&amp; frameborder=“0” style=“border: medium none;”></iframe>, which generates an iframe including social content generated based on the customization rules specified in the instruction. In this example, the widget includes display parameters for height, width, and border style of the iframe. In some embodiments, the customization rules include display criteria specifying how the social information is formatted or otherwise presented. In some embodiments, the customization rules include filtering criteria, such as ranking criteria, to further customize presentation of the social information.

The third-party website 120 sends 520 the markup language document describing the generated web page including an instruction for requesting social information (e.g., the widget) and the customization rules to the user device 110 through a network. After receiving the markup language document, the browser renders 525 the web page based on the content and formatting instructions included in the markup language document. In addition to rendering the web page, the browser in the user device 110 executes the instruction for requesting social information from the social networking system 130. For example, the browser in the user device 110 executes the widget to create 530 a frame, such as an iframe, in the web page and to request 540 social content from the social networking system 130 for presentation in a region of the web page (e.g., the frame). The request sent to social networking system 130 includes the customization rules specified in the web page. In some embodiments, the request sent to the social networking system 130 includes information identifying a user of the social networking system. For example, the request may include a user identifier that identifies the profile for the user.

Responsive to receiving the request for social information from the browser, the social networking system 130 identifies the user associated with the request. In some embodiments, the social networking system 130 identifies the user through information in the request. In some embodiments, the social networking system 130 checks 545 the user device 110 for a cookie identifying the user and indicating whether the user has been authenticated on the social networking system 130. In response to the social networking system 130 checking for the cookie, the user device 110 sends 550 the cookie, or a message associated with the cookie, to the social networking system 130. In one embodiment, the existence of cookie indicates whether the user of the user device 110 is a user of the social networking system 130 (e.g., whether the user has a valid account with the social networking system 130). If the user of the user device 110 is a user of the social networking system 130, the cookie may contain information indicating whether the user is logged into the social networking system 130 (e.g., whether the user has a current valid session with the social networking system 130). Thus, checking the user device 110 for a cookie allows the social networking system 130 to authenticate the user session. In other embodiments, the social networking system 130 may determine whether the user is a user of the social networking system 130, e.g., by checking for an existence of a cookie, without determining whether the user is logged into the social networking system 130. Although cookies are described herein for authenticating the user and/or the user session, any other methods of user or session or authentication may be used (such as recognizing a physical token).

If the user associated with the received cookie has been authenticated, the social networking system 130 determines 555 social information for the user based on the customization rules included in the request. As described above, the customization rules specify at least one object, at least one action type, and aggregation criteria. The social context module 132 of the social networking system determines the requested social information based on the customization rules and information associated with the user. Objects including the at least one object specified in the customization rules and one or more additional social graph objects associated with specified at least one social graph object are identified based on one or more action types specified in the customization rules. The requested information is aggregated from the set of identified social graph objects based on the aggregation criteria specified in the customization rules. As discussed above, the aggregation criteria may specify objects types, object properties, or action types, or any combination thereof

The requested information may include information about activities or actions of the user's connections and/or connections of the user's connections having an action type corresponding to at least one of the action types specified in the customization rules. The requested information may also include content items with which the user, the user's connections, and/or connections of the user's connections have interacted. In some embodiments, the requested information includes information from the profiles of the user, the user's connections, and/or connections of the user's connections.

The requested information may be formatted based on display criteria included in the customization rules. The customization rules may also include filtering criteria identifying information to exclude when aggregating the requested information. In some embodiments, the requested information is ranked in accordance with ranking criteria contained in the customization rules.

In one example, the customization rules specify an object for a band, an action type of “comment,” and aggregation criteria of “album.” In this example, the aggregation module 136 the band object and other objects connected to the band object by an action type of “comment,” then organizes the objects connected to the band object (e.g., comments about the band) based on the album that is being discussed. In another example, the customization rules specify a social graph object corresponding to “pizza,” an action type of “recommend,” and aggregation criteria of “restaurant.” This identifies pizza restaurant recommendations by users connected to the user viewing the web page, allowing the pizza restaurant recommendations to be displayed in a portion of the web page.

If the social networking system 130 is unable to authenticate the user associated with the received cookie, the social networking system 130 communicates a prompt for the user to enter authentication information into the user device 110 and determines information for presentation in a portion of the web page (e.g., a frame or iframe) based on actions taken by all users of the social networking system 130. Thus, until the social networking system 130 receives authentication information associated with the user associated with the received cookie, the information determined by the social networking system 130 may be global information, based on actions performed by all users of the social networking system 130 rather than on actions performed by friends or connections of the user associated with the received cookie. After receiving and verifying authentication information associated with the user associated with the cookie, the social networking system 130 determines information for presentation in the portion of the web page that is personalized for the user associated with the cookie, as described above.

Similarly, if the user device 110 does not send a cookie to the social networking system 130, it generates information for inclusion in a portion of the web page based on actions taken by all users of the social networking system 130 (i.e., global information rather than social content). In one embodiment, the social networking system 130 also presents a prompt for joining, or otherwise using, the social networking system 130 in the portion of the web page including the social information. Alternatively, the social networking system 130 generates information for presentation in a portion of the web page based on actions taken by all users of the social networking system 130 in response to receiving a message from the user device 110 that no cookie is stored.

The social networking system sends 560 the requested information for display in the portion of the web page, such as a frame or iframe. For example, the requested information is displayed using an iframe including a webpage in the domain of the social networking system 130. In one embodiment, the browser application included on the user device 110 renders 565 a frame including the social information received from the social networking system 130 (and in some embodiments information generated by the third-party website 120). The browser included on the user device 110 displays 570 the web page with the social information displayed in a portion of the web page. For example, the web page is displayed with the social information displayed in a frame or iframe included in the web page. By including the widget in the markup language document describing a web page, the third-party website 120 allows information from the social networking system 130 to be displayed along with the web page. Because the widget requests information from the social networking system 130 for inclusion in the frame, the third-party website 120 does not maintain, or even access, a user's social information, as the social networking system 130 personalizes and filters content after determining the user's personal information from the cookie stored on the user device 110.

### SUMMARY

The foregoing description of the embodiments of the invention has been presented for the purpose of illustration; it is not intended to be exhaustive or to limit the systems and methods to the precise forms disclosed. Persons skilled in the relevant art can appreciate that many modifications and variations are possible in light of the above disclosure.

Some portions of this description describe the embodiments of the systems and methods in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the systems and methods may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the systems and methods may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the systems and methods systems and methods be limited not by this detailed description, but rather by any claims that issue on an application based hereon. Accordingly, the disclosure of the embodiments of the systems and methods are intended to be illustrative, but not limiting, of the scope of the invention, which is set forth in the following claims.

What is claimed is:

1. A method comprising:
requesting a web page from a web server, wherein the web page is within a domain of a third-party website that is different from a domain of a social networking system;
receiving at a user device a markup language document for the requested web page, the markup language document including one or more customization rules identifying an object and an action type stored by the social networking system and aggregation criteria;
sending a request for information to the social networking system responsive to execution of an instruction in the markup language document, wherein the request includes the one or more customization rules specified in the markup language document;
providing to the social networking system an identification of a user associated with the user device;
receiving social information about one or more users of the social networking system connected to the user associated with the user device from the social networking system, wherein the social information was determined by the social networking system applying the customization rules to stored data associated with the one or more users connected to the user associated with the user device; and
rendering the web page and the received social information within a portion of the web page.

2. The method of claim 1, wherein the portion of the web page comprises an iframe that contains a web page in the domain of the social networking system.

3. The method of claim 1, wherein the aggregation criteria are selected from the group consisting of social graph object types, social graph object properties, and action types.

4. The method of claim 1, wherein the customization rules further include display criteria for displaying the social information.

5. The method of claim 1, wherein the social information describes actions performed by the one or more users of the social networking system who have established a connection to the user associated with the user device, wherein the actions correspond to the at least one action type specified in the customization rules.

6. The method of claim 1, wherein the social information includes content items that the one or more users of the social networking system performed an action with, wherein the one or more users have established a connection with the user and wherein the action corresponds to the at least one action type specified in the customization rules.

7. The method of claim 1, wherein the social information includes profile information for the one or more users who have established a connection with the user associated with the user device.

8. The method of claim 1, wherein the customization rules include filtering criteria for filtering the requesting information.

9. The method of claim 1, wherein the customization rules include ranking criteria for ranking the requested information.

10. A method comprising:
receiving at a server of a social networking system a request for information based on an instruction in a markup language document, wherein the request for information is responsive to a request for a web page of a third-party website that is within a domain of a third-party website that is different from a domain of the social networking system;
determining a set of customization rules from the request, wherein the customization rules are specified in the markup language document and wherein the customization rules specify at least one social graph object, at least one action type, and aggregation criteria;
identifying a user associated with the request;
determining the requested information based on the customization rules and information associated with the user; and
sending the requested information for display in the frame of the web page.

11. The method of claim 10, further comprising formatting the requested information in accordance with display criteria contained in the customization rules.

12. The method of claim 10, wherein the frame comprises an iframe that contains a web page in the domain of the social networking system.

13. The method of claim 10, wherein identifying the user comprises accessing a cookie stored on the user device.

14. The method of claim 10, wherein determining the requested information comprises:
aggregating information describing actions by one or more users of the social networking system who have established a connection to the user associated with the request, wherein the actions correspond to the at least one action type specified in the customization rules.

15. The method of claim 10, wherein determining the requested information comprises:
aggregating content items that one or more users of the social networking system performed an action with, wherein the one or more users have established a connection with the user associated with the request and wherein the action corresponds to the at least one action type specified in the customization rules.

16. The method of claim 10, wherein determining the requested information comprises:
identifying a set of social graph objects, the set of social graph objects comprising the at least one social graph object specified in customization rules and one or more additional social graph objects associated with the at least one social graph object specified in the customization rules based on the at least one action typed specified in the customization rules; and
aggregating the requested information from the identified set of objects based on the aggregation criteria specified in the customization rules.

17. The method of claim 10, further comprising ranking the requested information in accordance with ranking criteria contained in the customization rules.

18. The method of claim 10, further comprising filtering requested information in accordance with filtering criteria contained in the customization rules.

19. A method comprising:
receiving a request for a web page, wherein the web page is within a domain of a third-party website that is different from a domain of a social networking system;
obtaining a markup language document for the requested web page, the markup language document including customization rules and an instruction to create a frame within the web page that includes information obtained from the social networking system, wherein the customization rules specify at least one social graph object, at least one action type, and aggregation criteria; and
sending the requested markup language document to the user device, wherein the markup language document comprises instructions that cause the user device to:
send the social networking system a request for information that includes the customization rules,
provide to the social networking system an identification of a user associated with the user device,
receive the requested information from the social networking system, wherein the information received was determined by the social networking system based on the customization rules and information associated with the user,
render the web page including the requested information contained within the frame, and
display the rendered web page on a user device.

20. The method of claim 19, wherein the frame comprises an iframe that contains a web page in the domain of the social networking system.

21. The method of claim 19, wherein the requested information describes actions performed by the one or more users of the social networking system who have established a connection to the user associated with the user device, wherein the actions correspond to the at least one action type specified in the customization rules.

22. The method of claim 19, wherein the requested information includes content items that the one or more users of the social networking system performed an action with, wherein the one or more users have established a connection with the user and wherein the action corresponds to the at least one action type specified in the customization rules.
